(19) United States
(12) Patent Application Publication
(10) Pub. No.: US 2005/0080688 A1
(43) Pub. Date: Apr. 14, 2005

(54) System and method for managing and delivering traveler owned items

(76) Inventor: David Joseph Ruskauff, Geneseo, NY (US)

Correspondence Address: David Joseph Ruskauff, 137 Lima Road, Geneseo, NY, 14454, US

(21) Appl. No.: 10/958,134

(22) Filed: Oct. 4, 2004

Related U.S. Application Data
(60) Provisional application No. 60/508,168, filed on Oct. 2, 2003.

(51) Int. Cl. G06F 17/60

(52) U.S. Cl. 705/28

(57) ABSTRACT

According to a computer-implemented approach for managing and delivering customer owned items, customers specify what items to deliver and where to deliver said items. According to the approach, customer items are returned for storage after use. According to the approach, items are stored and managed on behalf of the customer.

### CROSS REFERENCE TO RELATED APPLICATIONS

This application is related to and claims the benefit of U.S. provisional application No. 60/508,168 entitled “System and Method for managing and delivering traveler owned items” filed Oct. 02, 2003.

### STATEMENT REGARDING FEDERALLY SPONSORED RESEARCH OR DEVELOPMENT

Not Applicable.

### REFERENCE TO MICROFICHE APPENDIX

Not Applicable.

### FIELD OF INVENTION

The present invention relates to an inventory management and delivery system, and more specifically, to an approach for providing a service to business, and leisure travelers, to provide for the maintenance, storage, delivery to a destination, and return, of items owned by the traveler.

### BACKGROUND OF THE INVENTION

Each year millions of business and leisure travelers cumulatively spend hundreds millions of nights in commercial lodging facilities. In almost every case, the travelers sleep in bedding materials owned and cleaned by the lodging facilities. This approach suffers from several significant problems affecting the traveler.

First, the cleanliness of the bedding materials is questionable. While sheets and pillowcases are generally cleaned and changed on a daily basis, other bedding, such as blankets, comforters, and pillows, typically are not. This poses several potential health risks for a traveler:

Bed Bugs

The United States has seen a resurgence of bedbug infestations in the last several years. Although normally believed to be limited to unclean environments, bedbugs typically infest areas with high occupancy rates, including upscale hotels.

Allergens

It has long been established that house mites (family Pyroglyphidae) are a source of house dust allergens that not only cause allergies but also adversely contribute to other pathologies, such as asthma. Inadequately laundered pillows have been shown to contain up to ten percent of their weight in dust mites and fecal matter.

Infectious Diseases

Numerous references exist in the media regarding the lack of cleanliness of bedding in the lodging industry, particularly the blankets and comforters. Contaminants cited typically include bodily fluids such as semen, and human fecal matter. These contaminants pose a potential health risk for the traveler. For example, both HIV and HBV (Hepatitis B) can survive in dried blood products for up to one and seven days, respectively, and pose a risk to any traveler that comes into contact with them.

Second, sleeping in unfamiliar surroundings, including bedding, contributes to loss of sleep, increased stress, and higher rates of absenteeism for travelers post travel. The loss of sleep can be attributed to multiple physical and psychological factors several of which are that the quality of the bedding may be inferior to that in which the traveler is accustomed and stress caused by sleeping in bedding perceived to unclean. While many travel sites, and literature, advise travelers to carry their own pillows in order to overcome the unfamiliar surroundings problem this solution is inconvenient, increases the amount of baggage a traveler must deal with, and addresses only a portion of the overall problem.

Third, over the past several years, in an effort to conserve energy and natural resources, many lodgings have instituted programs to reduce the amount of daily laundry processed by asking travelers to elect to have their bedding, towels, and washcloths, laundered and replaced, periodically rather than daily. While these programs are obviously desirable, they suffer from being dependant on the traveler making a conscious decision and electing to participate.

Given the current demand for temporary lodging, and the deficiencies of the traditional approach to providing bedding materials, an approach for providing clean bedding materials, on demand, is highly desirable.

There is a further need to provide an approach for providing bedding materials that only the individual traveler has, or will ever, sleep in.

There is a further need to reduce the amount of laundry processed by lodging facilities in order to conserve energy and natural resources.

There is a further need for an approach to providing bedding materials for travelers that makes the management, delivery, and return, of bedding materials flexible, and convenient, to the traveler.

### SUMMARY

In accordance with the present invention, a system and method is provided to; allow travelers to provide, or purchase, one or more items; uniquely identify the one or more items; provide for the management, maintenance and storage of the one or more items; provide a method for the travelers to enter itinerary information prior to a trip; provide for the delivery, and return, of the one or more traveler owned items.

### OBJECTS AND ADVANTAGES

Accordingly, several objects and advantages of the present invention are:
a) to provide bedding material for travelers that is clean;
b) to provide bedding material that is free of common allergens;
c) to provide bedding material that is slept in by only the owning traveler;
d) to provide for the reduced risk of exposure for travelers to blood borne diseases and other pathogens associated with unclean bedding;
e) to provide a method for travelers to conveniently enter itinerary information, including lodging;
f) to provide a method for the management, maintenance, and storage, of traveler owned items;
g) to provide a method for the delivery, and return, of traveler owned items relieving the traveler from either forgoing having the items, or requiring the traveler to personally carry them;
h) to conserve energy and natural resources by reducing the amount of laundry processed by lodging facilities.

Other objects and advantages are that by increasing the physical and psychological comfort of the traveler the traveler may then enjoy an increase in the quality and length of sleep thus reducing the overall stress associated with travel. Further objects and advantages of my invention will become apparent from a consideration of the drawings and ensuing description.

### DESCRIPTION OF DRAWINGS

Embodiments of the invention are illustrated by way of example, and not by way of limitation, in the figures of the accompanying drawings and in which like reference numerals refer to similar elements and in which:

FIG. 1 is a diagram depicting an approach for receiving, managing, delivering, and returning traveler owned items.

FIG. 2 is a flow diagram depicting a traveler account setup approach according to an embodiment.

FIG. 3 is a diagram depicting a unique identifier according to an embodiment.

FIG. 4 is a flow diagram depicting an approach for initially receiving traveler owned items according to an embodiment.

FIG. 5 is a flow diagram depicting an approach for receiving shipping requests from a traveler according to an embodiment.

FIG. 6 is a flow diagram depicting an approach for receiving and processing traveler shipping requests according to an embodiment.

FIG. 7 is a flow diagram depicting an approach for processing returned traveler items according to an embodiment.

FIG. 8 is a block diagram of a computer system upon which embodiments of the invention may be implemented.

### DESCRIPTION OF INVENTION

In the following description, for the purposes of explanation, specific details are set forth in order to provide a thorough understanding of the invention. However, it will be apparent that the invention may be practiced without these specific details. In other instances, well-known structures and devices are depicted in block diagram form in order to avoid unnecessarily obscuring the invention.

Various aspects and features of the example embodiments are described in more detail hereinafter in the following sections: (1) functional overview; (2) traveler account setup; (3) identification of traveler items; (4) receipt of traveler owned items; (5) traveler shipping request; (6) processing shipping requests; (7) return of traveler items; (8) implementation mechanisms.

### 1. Functional Overview

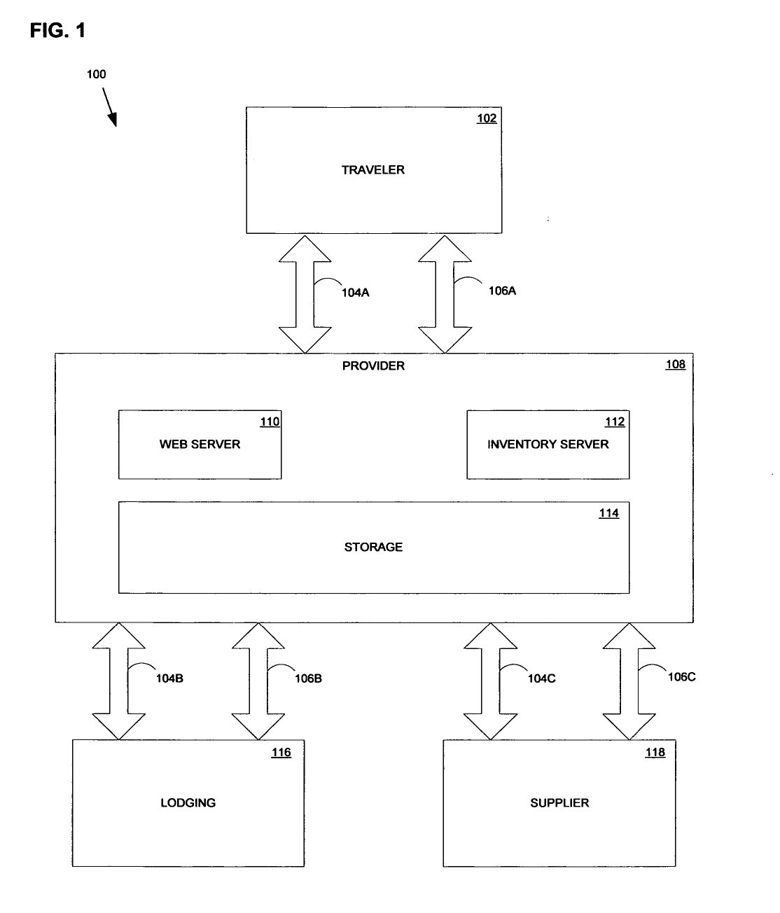

FIG. 1 is a block diagram 100 that illustrates an approach for receiving, managing and delivering traveler owned items on demand according to various embodiments described herein. As used herein, the term “items” refers to one or more articles of bedding but shall include without limitation any physical property that is owned by the traveler. Examples of items include bedding materials, towels, washcloths, clothing, sporting goods, electronics, and tools. In general the decision of what items that a traveler wants to have stored, managed, delivered and returned, is separated from the decision of when, and where, to have them delivered.

According to one embodiment, a traveler 102 provides items to a provider 108 for storage in a storage facility 114 via a delivery channel 104A. Data related to items provided by traveler 102 are retrieved from, and entered into, an inventory server 112. Prior to a trip traveler 102 provides item selection criteria and delivery criteria, including lodging, to provider 108, via a communication link 106A. In response to, and based upon, the criteria provided by traveler 102, provider 108 retrieves items from facility 114 according to data on server 112 and delivers them to a lodging 116 via a delivery channel 104B. Lodging 116 in response to receipt of traveler 102 items either delivers traveler 102 items to traveler 102 or prepares travelers 102 room with travelers 102 items.

After the departure of traveler 102 from lodging 116 items are returned to provider 108 via channel 104B and returned to facility 114.

According to another embodiment, traveler 102 may purchase items offered for sale by provider 108 rather than personally providing the items. Traveler 102 provides item selection criteria to provider 108 via link 106A. Provider 108 in response to traveler 102 selection criteria orders items from a supplier 118 via a communications link 106C. Supplier 118 in response to the order supplies the selected items to provider 108 via a delivery channel 104C. Provider 108 places items received via channel 104C in facility 114. Data related to items provided by supplier 118 are retrieved from, and entered into, server 112.

According to an embodiment, information related to traveler 102, including items being delivered, and itinerary, are provided via a communications link 106B to lodging 116 in order to better coordinate services for traveler 102.

According to an embodiment, communication channels 106 are Internet based channels and are connected to a one or more web server 110. However, communications channels 106A, 106B, and 106C may be implemented by any mechanism or medium that provides for the transfer of information, and the invention is not limited to any particular type of communication channel. Examples of communication channels 106 include without limitation telephone, fax, e-mail, WAN, LAN, or Internet. Server 110 and server 112 may be implemented in hardware, software, or a combination of hardware and software.

Delivery channels 104A, 104B and 104C may be implemented by any mechanism or medium that provides for the transfer of items, and the invention is not limited to any particular type of delivery channel. Examples of delivery channels 104 include without limitation mail delivery, commercial delivery services, courier delivery, or delivery using a delivery agent.

Provider 108 may be centralized or distributed depending upon the requirements of the application.

According to an embodiment, where traveler 102 items are bedding, towels or washcloths, traveler 102 items are not laundered by lodging 116.

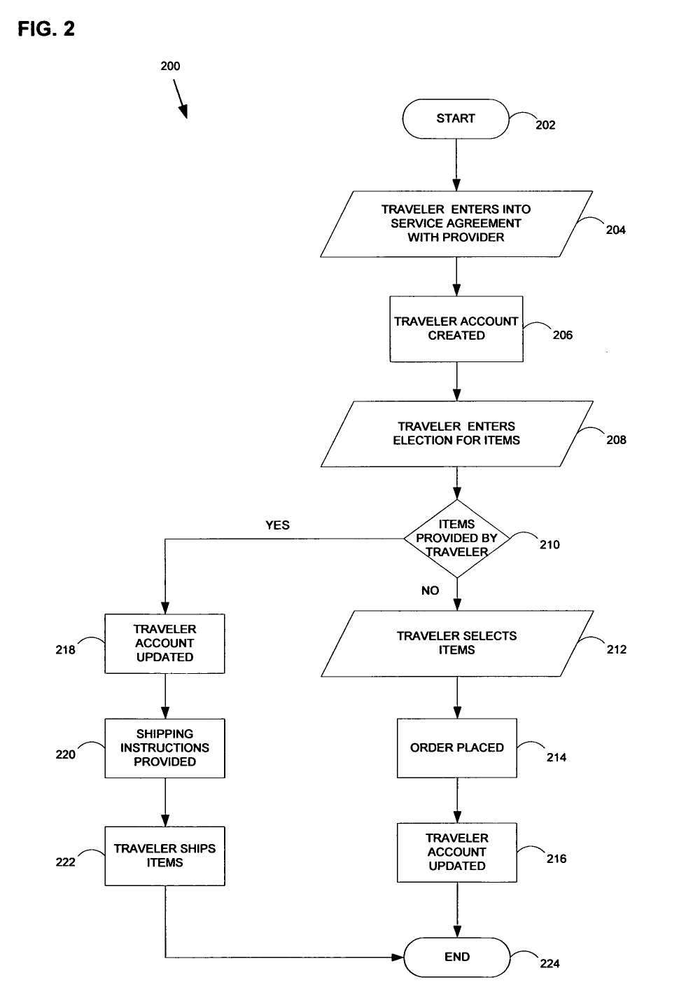

The approach just described for receiving traveler owned items is now described with reference to flow diagram 200 of FIG. 2.

### 2. Traveler Account Setup

After starting in step 202, traveler 102 enters into a service agreement with provider 108 in step 204. In response to agreement 204 an account is created on server 112 in step 206 for the traveler 102. In step 208 traveler 102 enters an election to either provide the initial items or purchase the items. In step 210 a determination is made whether traveler 102 is providing the items or purchasing the items. If the items are being purchased, traveler 102 selects the items to be purchased in step 212. In step 214, as a result of the selection, an order for the items is placed with supplier 118. Once the order has been placed with supplier 118, the traveler 102 account is updated on server 112 in step 216. The process is complete in step 224.

If traveler 102 elects to provide the items in step 208 control is passed to step 218 as a result of the determination made in step 210. In step 218 the traveler 102 account is updated on server 112. In step 220, traveler 102 is provided with shipping instructions for the items being provided by traveler 102. In step 222 traveler 102 ships initial items to provider 108 according to shipping instructions provided in step 220. The process is complete in step 224.

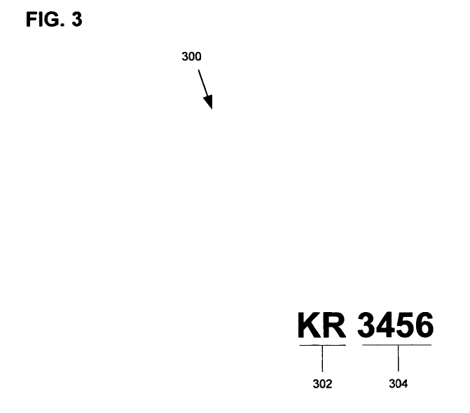

The description of an approach for receiving traveler 102 owned items is continued with reference to an identifier 300 of FIG. 3.

### 3. Identification of Traveler Items

In order to sufficiently manage, store, and deliver, traveler 102 owned items, a method of uniquely marking, and identifying, the items must be employed. According to an embodiment, identifier 300 is used to mark, and identify, traveler 102 owned items. Identifier 300 is comprised of two parts; a prefix 302, and a suffix 304. Where, prefix 302 is comprised of the initials of traveler 102, and suffix 304 is comprised of a computer generated identifier comprised of any unique, alphanumeric, identifier comprised of one or more characters. By way of example, and not limitation, identifier 300 is comprised of a two-character prefix 302 and a four-character suffix 304.

According to an embodiment, identifier 300 is used to mark traveler 102 owned items by being embroidered on the items.

According to another embodiment, identifier 300 is used to mark traveler 102 owned items by being stamped with indelible ink on the items.

It will be apparent to any person skilled in the art that the method described for identifying items may be accomplished through various other means and methods and that the invention is not limited to the methods described. Specifically, any method, or means, of uniquely identifying items shall be understood to be part of the invention. Examples of identification means and methods include, without limitation, alpha-numeric identifiers, bar codes, and RF Id tags, whether affixed directly to the items or not.

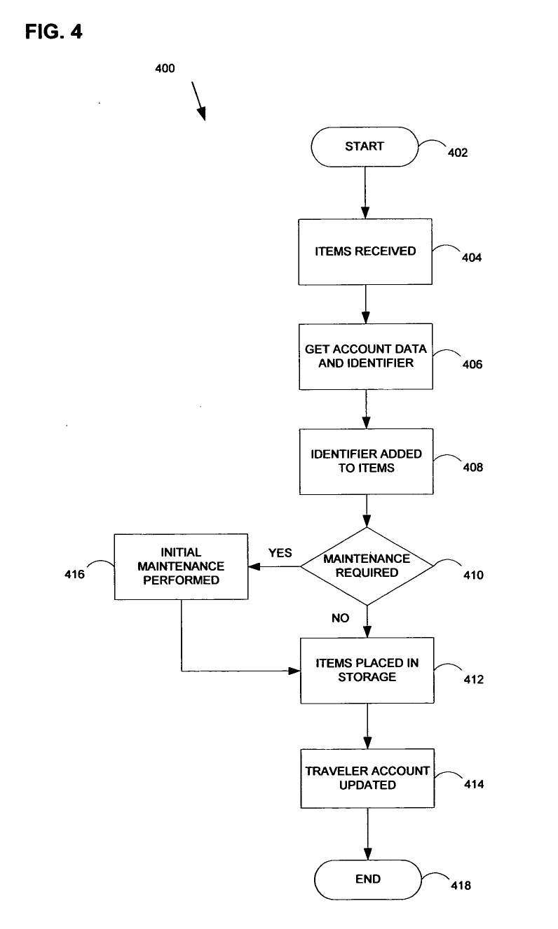

The description of an approach for receiving traveler 102 owned items is continued with reference to flow diagram 400 of FIG. 4.

### 4. Receipt of Traveler Owned Items

After starting in step 402, traveler 102 owned items are received in step 404 as a result of setup 200. In step 406, data related to the traveler 102 owned items and identifier are 300 retrieved from server 112. In step 408, traveler 102 owned items are embroidered with identifier 300. In step 410 a determination is made whether any maintenance is required on the traveler 102 owned items based on data retrieved from server 112 in step 406. If maintenance is required, the required maintenance is performed in step 416. If no maintenance is required as determined in step 410, or after the required maintenance is performed in step 416, the items are placed in facility 114 in step 412. The traveler 102 account on server 112 is updated in step 414. The process is complete in step 418.

The type of maintenance to be performed in step 416 is based on the nature of the items and the service agreement of step 204. Examples of maintenance include, without limitation, cleaning, laundering, dry cleaning, folding, assembly, and disassembly

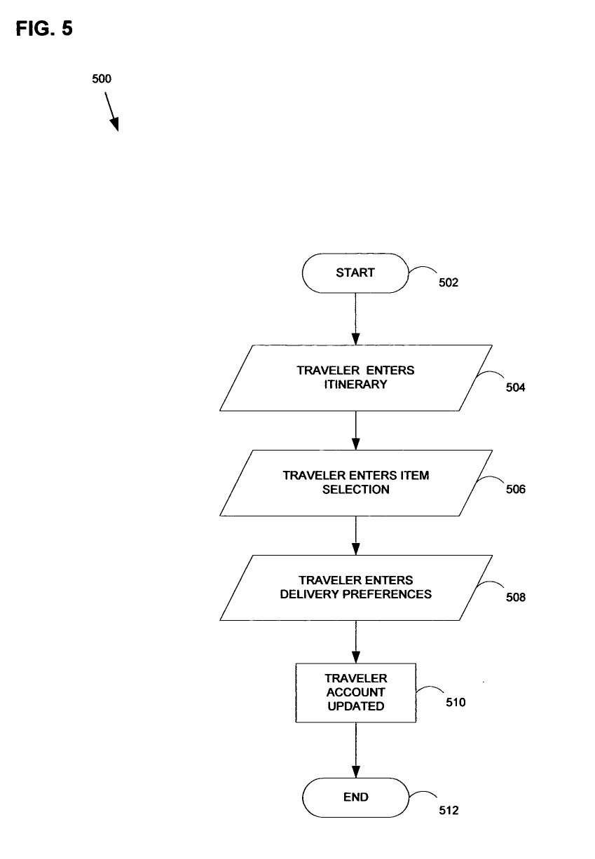

The approach described in section 1 for receiving traveler shipping requests is now described with reference to flow diagram 500 of FIG. 5.

### 5. Traveler Shipping Request

Prior to a trip, customer 102 must request the shipping of items from provider 108 to lodging 116. According to an embodiment, traveler 102 after starting in step 502, enters itinerary data in step 504 via link 106A. In step 506, traveler 102 enters selection of items for shipping via link 106A. In step 508, traveler 102 enters delivery preferences via link 106A. In step 510, traveler 102 account on server 112 is updated with selections and preferences entered in steps 504, 506, and 508. The process is complete in step 512.

Itinerary data entered in step 504 includes, but is not limited to, destination lodging, date of arrival, and date of departure. Selection of items in step 506 allows for traveler 102 to select one or more items owned by traveler 102 and stored by provider 108 to be delivered to lodging 116. Delivery preferences entered in step 508 include, but are not limited to, method of delivery, and method of return, of traveler 102 owned items. By way of example, but not limitation, delivery and return methods include overnight express delivery, regular overnight delivery, 2-day delivery, 3-day delivery, and Saturday delivery.

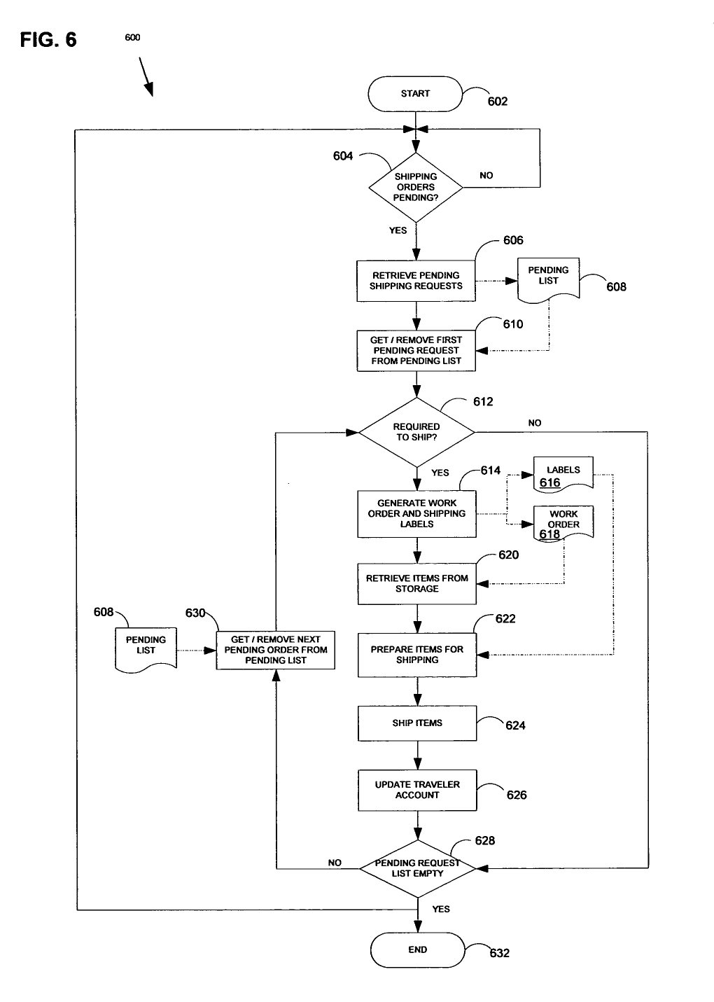

The approach described in section 1 shipping traveler owned items is now described with reference to flow diagram 600 of FIG. 6.

### 6. Processing Shipping Requests

According to an embodiment the processing of shipping requests occurs on a continual basis. After starting in step 602, in step 604 a determination is made if any shipping requests are pending and unfulfilled on server 112. If no shipping requests are pending and unfulfilled the determination step 604 repeats until one or more pending and unfulfilled shipping requests exist.

If as a result of the determination step 604 pending and unfulfilled shipping requests exist the pending and unfulfilled shipping requests are retrieved from server 112 in step 606 and output in a list 608. Step 610, retrieves and removes the first shipping request from list 608.

A determination is made in step 612 of whether the items in the shipping request from the previous step are required to ship. This determination can be made based on a variety of factors including, but not limited to, arrival date of traveler 102 at lodging 116, and traveler selected delivery methods. If the items are required to ship as determined in step 612 a work order 618 and shipping labels 616 for the delivery and return of customer 102 owned items are generated in step 614. The items being shipped are retrieved from storage in step 620 based on order 618. The items retrieved in step 620 are prepared for shipping in step 622 where preparation includes, but is not limited to, packaging, and affixing delivery and return labels 616. Items prepared in step 622 are shipped to lodging 116 in step 624. The traveler 102 account on server 112 is updated to reflect the status of the items in step 626.

A determination is made in step 626 if any requests exist in list 608. If no further requests exist the process continues at step 604.

If the determination of step 612 is that the pending and unfulfilled shipping request is not required to be shipped control passes to step 628.

If the determination of step 628 is that pending and unfulfilled shipping requests exist in list 608 control passes to step 630. In step 630 the next pending request in list 608 is retrieved and removed from list 608. Control passes to step 612.

The process ends in step 632.

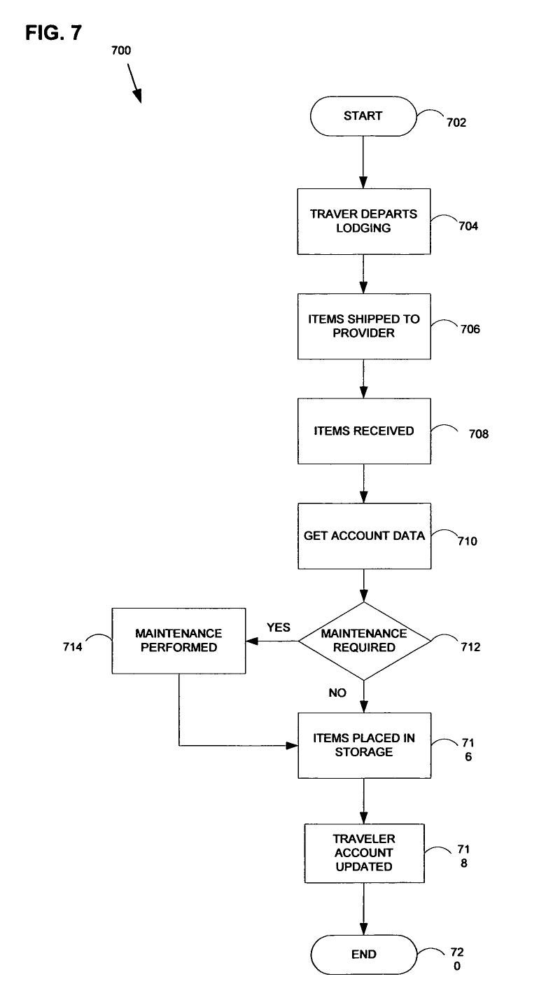

The approach described in section 1 of receiving returned traveler owned items is now described with reference to flow diagram 700 of FIG. 7.

### 7. Return of Traveler Items

After starting in step 702, in step 704 traveler 102 departs lodging 116. In step 706 traveler 102 owned items are shipped to provider 108. In step 708 provider 108 receives traveler 102 owned items. In step 710 data related to traveler 102 owned items are retrieved from server 112. In step 712 a determination is made whether any maintenance is required on the traveler 102 owned items based on data retrieved from server 112 in step 710. If maintenance is required, the required maintenance is performed in step 714. If no maintenance is required as determined in step 712, or after the required maintenance is performed in step 714, the items are placed in facility 114 in step 716. In step718, the traveler 102 account on server 112 is updated. The process is complete in step 720.

The type of maintenance to be performed in step 714 is based on the nature of the items and the service agreement of step 204. Examples of maintenance include, without limitation, cleaning, laundering, dry cleaning, folding, assembly, and disassembly

### 8. Implementation Mechanisms

The approach described herein for managing traveler owned items is applicable to any type of inventory application and (without limitation) is particularly well suited for Internet-based inventory applications. The invention may be implemented in hardware circuitry, in computer software, or a combination of hardware circuitry and computer software and is not limited to a particular hardware or software implementation.

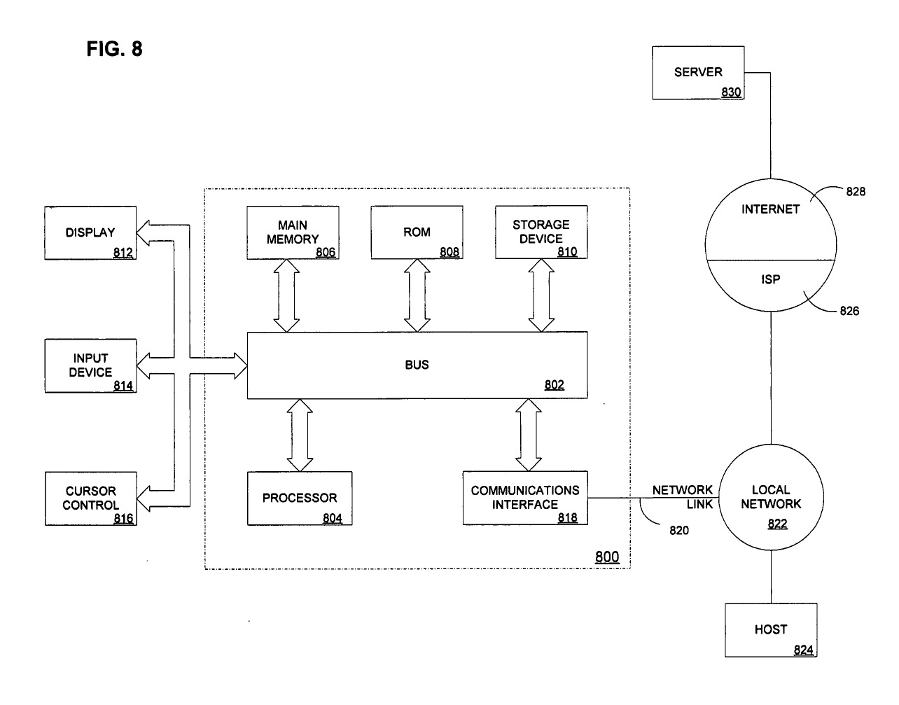

FIG. 8 is a block diagram that illustrates a computer system 800 upon which an embodiment of the invention may be implemented. Computer system 800 includes a bus 802 or other communication mechanism for communicating information, and a processor 804 coupled with bus 802 for processing information. Computer system 800 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Computer system 800 further includes a read only memory (ROM) 808 or other static storage device coupled to bus 802 for storing static information and instructions for processor 804. A storage device 810, such as a magnetic disk or optical disk, is provided and coupled to bus 802 for storing information and instructions. Computer system 800 may be coupled via bus 802 to a display 812, such as a cathode ray tube (CRT), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

The invention is related to the use of computer system 800 managing traveler owned items. According to one embodiment of the invention, the managing traveler owned items is provided by computer system 800 in response to processor 804 executing one or more sequences of one or more instructions contained in main memory 806. Such instructions may be read into main memory 806 from another computer-readable medium, such as storage device 810. Execution of the sequences of instructions contained in main memory 806 causes processor 804 to perform the process steps described herein. One or more processors in a multi-processing arrangement may also be employed to execute the sequences of instructions contained in main memory 806. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 804 for execution. Such a medium may take many forms, including but not limited to, non-volatile media, volatile media, and transmission media. Non-volatile media includes, for example, optical or magnetic disks, such as storage device 810. Volatile media includes dynamic memory, such as main memory 806. Transmission media includes coaxial cables, copper wire and fiber optics, including the wires that comprise bus 802. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 804 for execution. For example, the instructions may initially be carried on a magnetic disk of a remote computer. The remote computer can load the instructions into its dynamic memory and send the instructions over a telephone line using a modem. A modem local to computer system 800 can receive the data on the telephone line and use an infrared transmitter to convert the data to an infrared signal. An infrared detector coupled to bus 802 can receive the data carried in the infrared signal and place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the worldwide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are exemplary forms of carrier waves transporting the information.

Computer system 800 can send messages and receive data, including program code, through the network(s), network link 820 and communication interface 818. In the Internet example, a server 730 might transmit a requested code for an application program through Internet 828, ISP 826, local network 822 and communication interface 818. In accordance with the invention, one such downloaded application provides for the managing of traveler owned items as described herein.

The received code may be executed by processor 804 as it is received, and/or stored in storage device 810, or other non-volatile storage for later execution. In this manner, computer system 800 may obtain application code in the form of a carrier wave.

1. A system of managing customer owned items comprising:
A customer interface system
An inventory control system.
A delivery system.
